(19) United States
(12) Patent Application Publication
(10) Pub. No.: US 2012/0038561 A1
(43) Pub. Date: Feb. 16, 2012

(54) METHOD AND APPARATUS FOR DISPLAYING

(75) Inventor: Jae-lyong HAN, Cheonan-si (KR)

(73) Assignee: SAMSUNG ELECTRONICS CO., LTD., Suwon-si (KR)

(21) Appl. No.: 13/009,341

(22) Filed: Jan. 19, 2011

(30) Foreign Application Priority Data
Aug. 12, 2010 (KR) 10-2010-0077875

(51) Int. Cl. G06F 3/041

(52) U.S. Cl. 345/173

(57) ABSTRACT

A display method, which recognizes touch input information input to respective displays as multi-touch input, includes: displaying an image on a plurality of touch screens; receiving a plurality of pieces of touch input information from the plurality of touch screens; if respective pieces of the plurality of pieces of touch input information are received from different touch screens among the plurality of touch screens, performing a multi-touch operation with respect to the image.

### CROSS-REFERENCE TO RELATED APPLICATION

This application claims priority from Korean Patent Application No. 10-2010-0077875, filed on Aug. 12, 2010, in the Korean Intellectual Property Office, the disclosure of which is incorporated herein by reference in its entirety.

### BACKGROUND

1. Field

Methods and apparatuses consistent with exemplary embodiments relate to a method and an apparatus for displaying, and more particularly, to a method and an apparatus for displaying, which performs a multi-touch function with respect to an image using touch input information input from a multi-display apparatus.

2. Description of the Related Art

In the related art, if a single touch display apparatus receives at least two pieces of touch input information (as shown in FIG. 1, for example), the display apparatus may perform a multi-touch function, such as enlarging or reducing an image displayed on a screen, according to the received multi-touch input information.

Recently, as shown in FIG. 2, the technology for enlarging an image and dividing the image onto multi-displays using a video signal divider or a video wall function is being increasingly utilized. However, when the image is enlarged and divided onto the multi-displays, if a plurality of pieces of touch input information is input to one touch display apparatus, the touch input information is recognized as multi-touch input on the corresponding touch display apparatus. On the other hand, if a plurality of pieces of touch input information is input across the multi-displays, the touch input information is not recognized as multi-touch input, and is instead recognized as single touch input on each display apparatus.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

An aspect of the present invention provides a display method which may include: displaying an image on a plurality of touch screens; receiving a plurality of pieces of touch input information from the plurality of touch screens; if respective pieces of the plurality of pieces of touch input information are received from different touch screens among the plurality of touch screens, performing a multi-touch operation with respect to the image.

The displaying the image may include displaying the image by operating the plurality of touch screens as one display.

The operating of the plurality of touch screens as one display may include enlarging and dividing the image, and displaying the enlarged and divided image across plurality of touch screens.

The performing of the multi-touch operation may include: combining the plurality of pieces of touch input information; converting the combined touch input information into multi-touch input information so that the plurality of touch screens operate as one display; and performing the multi-touch operation based on the converted multi-touch input information.

The combining may include combining coordinates corresponding to the plurality of pieces of touch input information on the plurality of touch screens, wherein the converting comprises converting the combined coordinates into coordinates on the one display.

The converting may include converting coordinates corresponding to touch input information input according to respective identifications (IDs) of the plurality of touch screens into coordinates on the one display.

The multi-touch operation may include at least one of enlarging, reducing, and rotating the image.

The respective pieces of the plurality of pieces of touch input information may be input around a boundary between the plurality of touch screens.

The plurality of touch screens may be attached to one of portable devices and multi-touch screens.

Another aspect of the present invention provides a display apparatus which may include: a plurality of touch screens which display an image and receive a plurality of pieces of touch input information; a touch input information determination unit which determines whether respective pieces of the plurality of pieces of touch input information are touch input information of different touch screens; and a controller which, if the respective pieces of the plurality of pieces of touch input information are the touch input information of the different touch screens, controls the plurality of touch screens to perform a multi-touch operation with respect to the image according to the plurality of pieces of touch input information.

The controller may control the plurality of touch screens to operate as one display.

The controller may control the plurality of touch screens to operate as one display by enlarging and dividing the image, and displaying the enlarged and divided image across plurality of touch screens.

The controller may include: a touch input information combination unit which combines the plurality of pieces of touch input information; a touch input information conversion unit which converts the combined touch input information into multi-touch input information so that the plurality of touch screens operate as one display; and a multi-touch operation controller which controls the plurality of touch screens to perform the multi-touch operation based on the converted multi-touch input information.

The touch input information combination unit may combine coordinates corresponding to the plurality of touch input information on the plurality of touch screens, wherein the touch input information conversion unit converts the combined coordinates into coordinates on the one display.

The respective pieces of the plurality of pieces of touch input information may be received from the plurality of touch screens via at least one of a Bluetooth connection, a wireless connection, a cable connection and an application.

The touch input information conversion unit may convert coordinates corresponding to touch input information input according to respective identifications (IDs) for the plurality of touch screens into coordinates on the one display.

The multi-touch operation may include at least one of enlarging, reducing and rotating the image.

The display apparatus as claimed in claim 10, wherein the respective pieces of the plurality of pieces of touch input information are input around a boundary between the plurality of touch screens.

The plurality of touch screens may be attached to one of portable devices and multi-touch screens.

### BRIEF DESCRIPTION OF THE DRAWING FIGURES

The above and/or other aspects will be more apparent by describing in detail exemplary embodiments, with reference to the accompanying drawings, in which:

FIGS. 1 and 2 are views to explain a related-art multi-touch recognizing method;

FIG. 3 is a block diagram illustrating a display apparatus according to an exemplary embodiment;

FIG. 4 is a block diagram illustrating the controller of FIG. 3 in detail;

FIG. 5 is a view to explain a method for combining and converting touch input information on a display apparatus according to an exemplary embodiment; and

FIG. 6 is a flowchart illustrating a displaying method according to an exemplary embodiment.

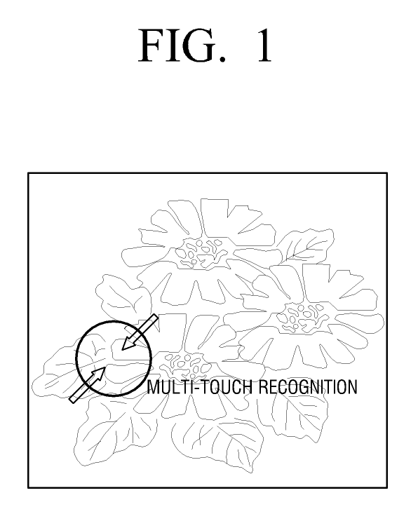

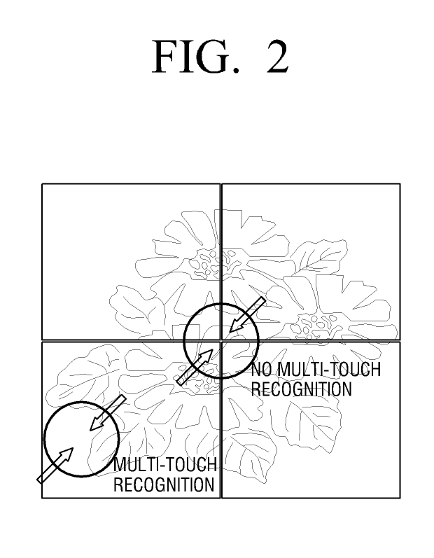

### DETAILED DESCRIPTION OF THE EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

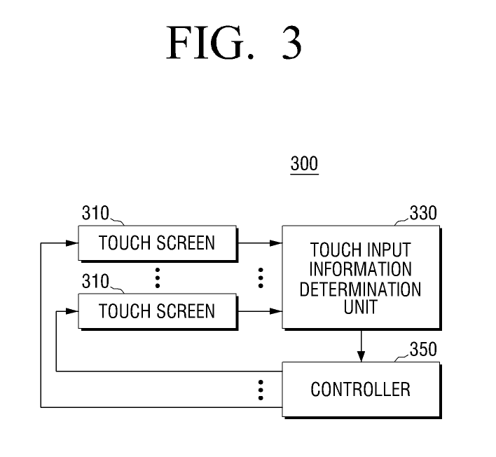

FIG. 3 is a block diagram illustrating a display apparatus 300 according to an exemplary embodiment. As shown in FIG. 3, the display apparatus 300 includes a plurality of touch screens 310, a touch input information determination unit 330, and a controller 350.

The plurality of touch screens 310 display an image and receive a plurality of pieces of touch input information. The touch input information recited herein may be a touch gesture input by a user on each touch screen, and the touch gesture may be a gesture of touching one point on the touch screen and sliding to another point over the screen.

In other words, the plurality of touch screens 310 display the image thereon and receive touch gestures corresponding to a multi-touch function such as enlarging, reducing, and rotating a displayed image therethrough.

The plurality of touch screens 310 may display the image as one display. In other words, one image is enlarged and divided onto the plurality of touch screens 310, so that the plurality of touch screen 310 displays the image as one display.

The plurality of touch screens 310 may be attached to portable devices or multi-touch screens.

In other words, the plurality of touch screens 310 may be touch screens of a multi-display system or touch screens attached to portable devices such as a mobile phone, an MP3 player, or a navigation system. Accordingly, the display apparatus 300 according to an exemplary embodiment displays one image by dividing it onto the multi-touch screens or dividing it onto the touch screens attached to the portable devices.

The plurality of pieces of touch input information may be input around a boundary between the plurality of touch screens 310. According to an exemplary embodiment, even if a plurality of pieces of touch input information are input around the boundary between the touch screens of the multi-display system, the input touch input information can be recognized as multi-touch input.

The plurality of touch screens 310 may receive touch input information through a touch pad and may be replaced with displays having the touch pad.

The touch input information determination unit 330 determines whether the respective pieces of the plurality of pieces of touch input information are touch input information of different touch screens or not.

In other words, the touch input information determination unit 330 determines whether touch gestures input from the plurality of touch screens 310 are touch input information of one touch screen or touch input information of different touch screens.

If the input touch gestures are a plurality of pieces of touch input information input from one touch screen, the controller 350, which will be described later, recognizes the input touch gestures as multi-touch input on the corresponding touch screen, and, if the input touch gestures are touch input information input from different touch screens, the controller 350 recognizes the input touch gestures as multi-touch input on the whole screen including the plurality of touch screens.

If the touch input information determination unit 330 determines that the respective pieces of the plurality of pieces of touch input information are touch input information of different touch screens, the controller 350 controls the plurality of touch screens 310 to perform a multi-touch function with respect to the image according to the input plurality of pieces of touch input information.

The multi-touch function may include at least one function of the functions of enlarging, reducing, and rotating the image displayed on the plurality of touch screens 310.

In other words, the controller 350 may control the plurality of touch screens 310 to perform one of the functions of enlarging, reducing, and rotating the image according to the input plurality of pieces of touch input information.

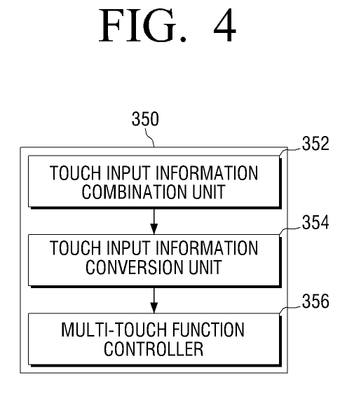

The controller 350 includes a touch input information combination unit 352, a touch input information conversion unit 354, and a multi-touch function controller 356, as shown in FIG. 4.

The touch input information combination unit 352 combines the plurality of pieces of touch input information input from the plurality of touch screens 310.

In other words, if user's touch gestures are input to the plurality of touch screens 310, which are operated as one display, the touch input information combination unit 352 combines touch input information on the touch screens to which the corresponding touch gestures are input.

According to an exemplary embodiment, the touch input information combination unit 352 may combine coordinates on the plurality of touch screens 310, which correspond to the input plurality of pieces of touch input information.

For example, if touch input information is input to a touch screen ‘A’ and a touch screen ‘B’, the touch input information combination unit 352 combines coordinates corresponding to the touch input information on the touch screen ‘A’ and coordinates corresponding to the touch input information on the touch screen ‘B’.

The touch input information combination unit 352 may combine the touch input information received from the plurality of touch screens 310 in at least one method of Bluetooth, wireless, cable, and application methods.

In other words, the touch input information combination unit 352 may receive the touch input information from the respective touch screens by a cable, wirelessly, using Bluetooth, or using an application.

The touch input information conversion unit 354 converts the combined touch input information into multi-touch input information so that the plurality of touch screens 310 can operate as one display.

In other words, the touch input information conversion unit 354 converts the combined touch input information obtained from the respective touch screens into multi-touch input information on one display, so that the respective touch screen operate as one display.

According to an exemplary embodiment, the touch input information conversion unit 354 converts the coordinates combined by the touch input information combination unit 352 into coordinates on one display.

For example, if coordinates corresponding to the touch input information of the touch screen ‘A’ is ‘a’ and if coordinate corresponding to the touch input information of the touch screen ‘B’ is ‘b’, the touch input information conversion unit 354 assumes that the respective touch screens form one display and converts the coordinates ‘a’ and ‘b’ of the respective touch screens into coordinates on one display. The coordinates of the touch input information are simply expressed by ‘a’ and ‘b’ for convenience of explanation, but the touch input information may have values corresponding to x, y coordinates on the touch screen and may include coordinates of a first point at which touch on the touch screen starts and coordinates of a second point at which the touch ends.

The touch input information conversion unit 354 may convert the coordinates corresponding to the touch input information input according to identifiers or identifications (IDs) given to the plurality of touch screens 310 into coordinates on one display.

For example, if four touch screens having IDs ‘A’, ‘B’, ‘C’, and ‘D’ operate as one display and touch input information are input to the touch screens having IDs ‘A’ and ‘B’, the touch input information conversion unit 354 converts the touch input information of the touch screen of the ID ‘A’ into coordinates on one display and converts the touch input information of the touch screen of the ID ‘B’ into coordinates on one display.

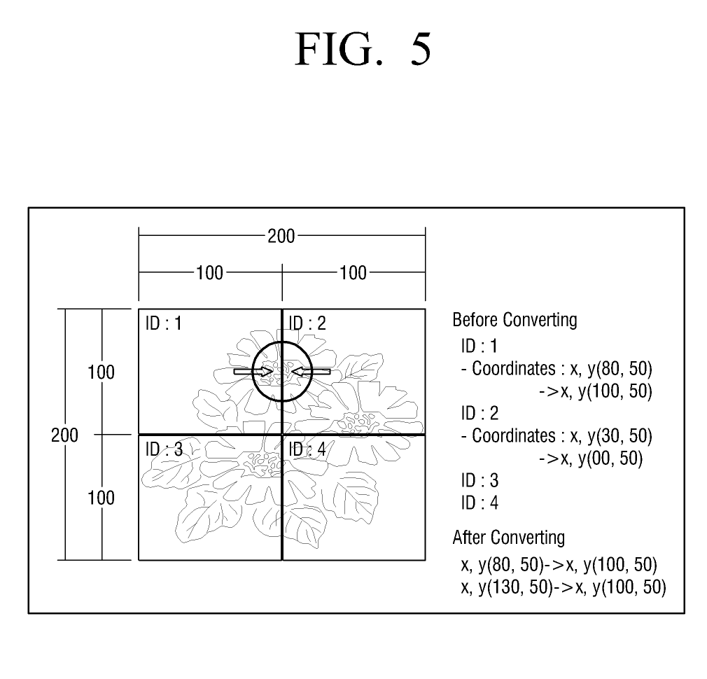

Hereinafter, a detailed method for combining and converting touch input information will be explained in detail with reference to FIG. 5.

As shown in FIG. 5, four touch screens operate as one display and have IDs 1, 2, 3, and 4, respectively. Also, each touch screen has a size of 100 by 100. Therefore, if the four touch screens operate as one display, the whole display has a size of 200 by 200.

Also, x, y coordinates of a start point of touch input information of the touch screen of the ID ‘1’ is (80, 50) and x, y coordinates of an end point of the touch input information of the touch screen ‘1’ is (100, 50), and x, y coordinates of a start point of touch input information of the touch screen of the ID ‘2’ is (30, 50) and x, y coordinates of an end point of the touch input information of the touch screen ‘2’ is (00, 50). Also, no touch input information is input to the touch screens of the IDs ‘3’ and ‘4’.

The touch input information combination unit 352 combines the touch input information for the touch screens' IDs and the touch input information conversion unit 354 converts the combined touch input information into multi-touch input information so that the touch screens operate as one display.

For example, as shown in FIG. 5, in order to allow the four touch screens to operate as one display, the touch input information of the touch screen of the ID ‘1’, which moves from coordinates (80, 50) to coordinates (100, 50), is converted to multi-touch input information which moves from coordinates (80, 50) to coordinates (100, 50), and the touch input information of the touch screen of the ID ‘2’, which moves from coordinates (30, 50) to coordinates (00, 50), is converted into multi-touch input information which moves from coordinates (130, 50) to coordinates (100, 50).

Referring back to FIG. 4, the multi-touch function controller 356 controls the plurality of touch screens 310 to perform the multi-touch function corresponding to the converted multi-touch input information.

For example, the multi-touch function controller 356 controls the respective touch screens to perform the multi-touch function such as enlarging, reducing, or rotating the image according to the gesture of the converted multi-touch input information of one display.

Accordingly, by combining the touch input information of the respective touch screens and converting the combined touch input information into multi-touch input information of one display, the display apparatus is able to recognize the touch input information input around the boundary between the touch screens as multi-touch input information. Also, if the touch screens, each of which is capable of recognizing single touch input information, operate as one display, the touch input information of the respective touch screens can be recognized as multi-touch input information.

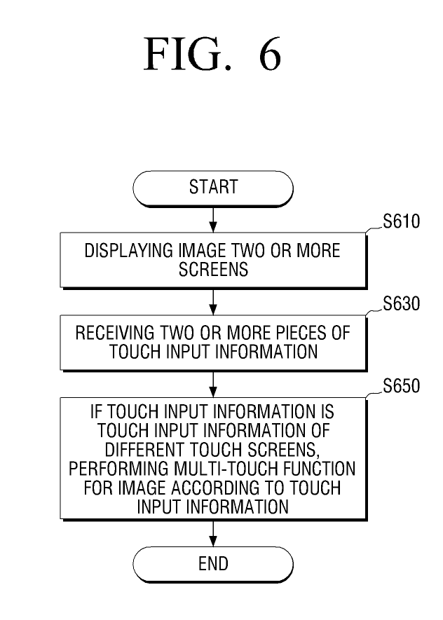

FIG. 6 is a flowchart illustrating a display method according to an exemplary embodiment.

An image is displayed on plurality of touch screens (S610).

The operation of displaying the image (S610) displays the image by operating the plurality of touch screens as one display. In other words, the plurality of touch screens displays one image as one display by enlarging the image and dividing the image onto the plurality of screens.

The plurality of touch screens may be touch screens attached to portable devices or multi-touch screens. In other words, the plurality of touch screens may be touch screens of a multi-display system or touch screens attached to portable devices such as mobile phones, MP3 players, or navigation systems. Therefore, the display method according to an exemplary embodiment may display one image by dividing it onto the multi-touch screens or by dividing it onto screens attached to the portable devices.

Next, respective pieces of the plurality of pieces of touch input information are input from the plurality of touch screens (S630). The touch input information may be a touch gesture input to the touch screen by the user. The touch gesture may be a gesture of touching one point on the screen and sliding to another point over the screen.

The plurality of pieces of touch input information may be input around a boundary between the plurality of touch screens. According to an exemplary embodiment, even if a plurality of pieces of touch input information are input around the boundary between the touch screens of the multi-display system, the input touch input information can be recognized as multi-touch input.

The touch screen may receive touch input information through a touch pad and may be replaced with a display having the touch pad.

Finally, if the respective pieces of the plurality of pieces of touch input information are touch input information of different touch screens, a multi-touch function is performed with respect to the displayed image according to the input plurality of pieces of touch input information (S650).

Specifically, it is determined whether the touch gestures input from the plurality of touch screens are touch input information of one touch screen or touch input information of different touch screens. If the input touch gestures are a plurality of pieces of touch input information input from one touch screen, the input touch gestures are recognized as multi-touch input on the corresponding touch screen. If the input touch gestures are touch input information input from different touch screens, the touch gestures are recognized as multi-touch input on the whole screen including the plurality of touch screens, and the multi-touch function is performed with respect to the displayed image according to the recognized multi-touch input.

The multi-touch function may include at least one of the functions of enlarging, reducing, and rotating the image displayed on the plurality of touch screens.

In other words, the plurality of touch screens are controlled to perform a corresponding multi-touch function such as enlarging, reducing, and rotating the image according to the input plurality of pieces of touch input information.

The operation of performing the multi-touch function (S650) may include combining the input plurality of pieces of touch input information.

Specifically, the respective pieces of the input plurality of pieces of touch input information are combined using coordinates on each touch screen.

The display method according to an exemplary embodiment may combine the touch input information received from the plurality of touch screens using at least one method of Bluetooth, wireless, cable, and application methods.

The operation of performing the multi-touch function (S650) may include converting the touch input information which has been combined into multi-touch input information so that the plurality of touch screens operate as one display.

Specifically, the display method may convert the combined coordinates into coordinates on one display.

Also, the display method may convert coordinates corresponding to the touch input information input according to IDs given to the plurality of touch screens into coordinates on one display.

The operation of performing the multi-touch function (S650) may include performing the multi-touch function corresponding to the converted multi-touch input information.

According to the display method according to an exemplary embodiment, by combining the touch input information of the respective touch screens and converting the combined touch input information into multi-touch input information of one display, the touch input information input around the boundary between the screens is recognized as multi-touch input information. Also, if the touch screens, each of which is capable of recognizing single touch input information, operate as one display, the touch input information of the respective touch screens can be recognized as multi-touch input information.

The foregoing exemplary embodiments are merely exemplary and are not to be construed as limiting the present inventive concept. The exemplary embodiments can be readily applied to other types of apparatuses.

What is claimed is:

1. A display method comprising:
displaying an image on a plurality of touch screens;
receiving a plurality of pieces of touch input information from the plurality of touch screens;
if respective pieces of the plurality of pieces of touch input information are received from different touch screens among the plurality of touch screens, performing a multi-touch operation with respect to the image.

2. The display method as claimed in claim 1, wherein the displaying the image comprises displaying the image by operating the plurality of touch screens as one display.

3. The display method as claimed in claim 2, wherein the operating of the plurality of touch screens as one display comprises enlarging and dividing the image, and displaying the enlarged and divided image across plurality of touch screens.

4. The display method as claimed in claim 1, wherein the performing the multi-touch operation comprises:
combining the respective pieces of the plurality of pieces of touch input information;
converting the combined touch input information into multi-touch input information so that the plurality of touch screens operate as one display; and
performing the multi-touch operation based on the converted multi-touch input information.

5. The display method as claimed in claim 4, wherein the combining comprises combining coordinates corresponding to the plurality of pieces of touch input information on the plurality of touch screens,
wherein the converting comprises converting the combined coordinates into coordinates on the one display.

6. The display method as claimed in claim 4, wherein the converting comprises converting coordinates corresponding to touch input information input according to respective identifications (IDs) of the plurality of touch screens into coordinates on the one display.

7. The display method as claimed in claim 1, wherein the multi-touch operation includes at least one of enlarging, reducing, and rotating the image.

8. The display method as claimed in claim 1, wherein the respective pieces of the plurality of pieces of touch input information are input around a boundary between the plurality of touch screens.

9. The display method as claimed in claim 1, wherein the plurality of touch screens are attached to one of portable devices and multi-touch screens.

10. A display apparatus comprising:
a plurality of touch screens which display an image and receive a plurality of pieces of touch input information;
a touch input information determination unit which determines whether respective pieces of the plurality of pieces of touch input information are touch input information of different touch screens; and
a controller which, if the respective pieces of the plurality of pieces of touch input information are the touch input information of the different touch screens, controls the plurality of touch screens to perform a multi-touch operation with respect to the image according to the plurality of pieces of touch input information.

11. The display apparatus as claimed in claim 10, wherein the controller controls the plurality of touch screens to operate as one display.

12. The display apparatus as claimed in claim 11, wherein the controller controls the plurality of touch screens to operate as one display by enlarging and dividing the image, and displaying the enlarged and divided image across plurality of touch screens.

13. The display apparatus as claimed in claim 10, wherein the controller comprises:
a touch input information combination unit which combines the plurality of pieces of touch input information;
a touch input information conversion unit which converts the combined touch input information into multi-touch input information so that the plurality of touch screens operate as one display; and
a multi-touch operation controller which controls the plurality of touch screens to perform the multi-touch operation based on the converted multi-touch input information.

14. The display apparatus as claimed in claim 13, wherein the touch input information combination unit combines coordinates corresponding to the plurality of touch input information on the plurality of touch screens,
wherein the touch input information conversion unit converts the combined coordinates into coordinates on the one display.

15. The display apparatus as claimed in claim 13, wherein the respective pieces of the plurality of pieces of touch input information are received from the plurality of touch screens via at least one of a Bluetooth connection, a wireless connection, a cable connection and an application.

16. The display apparatus as claimed in claim 13, wherein the touch input information conversion unit converts coordinates corresponding to touch input information input according to respective identifications (IDs) for the plurality of touch screens into coordinates on the one display.

17. The display apparatus as claimed in claim 10, wherein the multi-touch operation includes at least one of enlarging, reducing and rotating the image.

18. The display apparatus as claimed in claim 10, wherein the respective pieces of the plurality of pieces of touch input information are input around a boundary between the plurality of touch screens.

19. The display apparatus as claimed in claim 10, wherein the plurality of touch screens are attached to one of portable devices and multi-touch screens.
